(19) United States
(12) Patent Application Publication
(10) Pub. No.: US 2001/0014271 A1
(43) Pub. Date: Aug. 16, 2001

(54) INCLUDING A TRANSFER ARM

(76) Inventors: SUK-KY SI, KYUNGKI-DO (KR); CHOI DUG-KYU, KYUNGKI-DO (KR)

Correspondence Address: JONES VOLENTINE STEINBERG & WHITT, 12200 SUNRISE VALLEY DRIVE, SUITE 150, RESTON, VA, 20191

(21) Appl. No.: 09/301,592

(22) Filed: Apr. 29, 1999

(30) Foreign Application Priority Data
May 26, 1998 (KR) 98-19114

(51) Int. Cl. B25J 11/00

(52) U.S. Cl. 414/416.08; 414/937; 414/939; 901/47; 118/719

(57) ABSTRACT

A transfer arm and apparatus including such a transfer arm. The arm includes a pushing mechanism to properly locate wafers in a wafer carrier prior to transfer. The transfer apparatus includes a vertically disposed sensor to detect misalignment of the wafers in the wafer carrier.

### BACKGROUND OF THE INVENTION

1. Field of the Invention

The present invention relates to a transfer arm for handling semiconductor wafers, and to a transfer apparatus for semiconductor wafers having such a transfer arm. More particularly, the present invention relates to a transfer arm, and transfer apparatus having a transfer arm with a sensor to precisely detect whether semiconductor wafers are correctly loaded into a carrier.

2. Description of the Related Art

Generally, semiconductor devices are manufactured by carrying out a sequence of fabrication processes. These semiconductor device fabrication processes are performed in or use an array of fabrication apparatuses. Important among this variety of equipment are those devices used to transfer wafers from one process apparatus to another. (The term “wafer” is used to connote either individual semiconductor wafers or sheets of wafers). Such transfer may be done manually or automatically by a computer controlled transfer apparatus. A common transfer apparatus loads a plurality of wafers into a wafer carrier from a fabrication apparatus, or unloads the plurality of wafers from the wafer carrier into a fabrication apparatus.

FIG. 1 shows a conventional wafer transfer apparatus including a carrier 10 having wafers loaded therein placed on a plate 12. Plate 12 moves up and down as necessary to transfer the wafers. A frame 14 for attaching various elements is placed over plate 12. Further, a lateral support member 15 stabilizes carrier 10 during movement.

In addition, a sensor 16 is provided on upper corners of frame 14, so as to be placed on the right and left sides of plate 12 with respect to the transfer direction of the wafers. Sensor 16 indicates whether any of the wafers have horizontally slipped from their correct location within carrier 10. In other words, as shown in some additional detail in FIG. 2, sensor 16 is provided in order to detect whether any wafer W slips from the wafer carrier 10. Such slippage will cause the wafer to break the plane established between opposite ends of sensor 16.

During the wafer transfer using the conventional transfer apparatus, plate 12 moves up and down, within the region designated by the phantom line in FIG. 1, using a measurement device such as a voltage difference detector. The vertical movement of carrier 10, as controlled by the measurement device, in conjunction with sensor 16 allows a transfer arm 20 to receive and transfer a wafer from carrier 10 to a fabrication device 18 at a proper height.

The placement of carrier 10 on plate 12 is typically done manually. Not surprisingly, this leads to loading errors. Such misalignment errors in the placement of carrier 10, or slippage of wafers within carrier 10 as the result of handling, create subsequent problems in the loading of wafers from carrier 10 into fabrication apparatus 18. That is, the loading of fabrication apparatus 18 is performed with the expectation that wafers within carrier 10 are properly placed. Any misalignment of the wafers may well result in a wafer being misplaced within fabrication apparatus 18.

As stated previously, sensor 16 is provided in an attempt to sense misaligned wafers. However, experience has shown that conventional sensor 16 is inadequate to sense all misalignment problems. Returning to FIG. 2, the structure of carrier 10 is such that its sides extend in the wafer transfer direction. Because of the structure of carrier 10, conventional sensor 16 can detect relatively gross misalignments of a wafer within carrier 10. Lesser deviations that do not cause the wafer to break the sensor plane are not detected. The difference between a precisely placed wafer and a gross misalignment will result in an undetected transfer error, like the one illustrated in FIG. 3, where the undetected deviation range of the wafer on transfer arm 20 is shown by A.

Such undetected transfer errors become especially pronounced in the case shown in FIG. 4, where wafers loaded in carrier 10 present their flat edge toward the fabrication apparatus. The flat edge increases the range between detected, gross misalignments and undetected misalignments.

In either case, undetected misalignments of the wafer within carrier 10 results in misplacement of the wafer within fabrication apparatus 18. Conventional sensor 16 is inadequate to prevent other than gross misalignments, and cannot take into account the structure of carrier 10, or the orientation of wafers within carrier 10. Misplacement of the wafers in the fabrication apparatus results in at least a decrease in productivity as operators must intervene to correct the processing failure. In more severe cases, semiconductor devices may be damaged by action of the fabrication apparatus on misplaced wafers.

### SUMMARY OF THE INVENTION

The present invention provides a transfer arm for carrying semiconductor wafers, and a transfer apparatus having such a transfer arm, wherein the transfer arm includes a sensor capable of determining whether or not the wafers are correctly loaded within a wafer carrier. Such ability prevents the processing failures due to the misalignment and misplacement of wafers in the fabrication apparatus, thereby improving the productivity of semiconductor devices.

Thus, in one aspect the present invention provides a transfer arm transferring semiconductor wafers from a wafer carrier to a fabrication apparatus, the wafer carrier having a correct position in which each one of the wafers is placed, the transfer arm comprising; a lateral arm member having one end adapted to extend into the wafer carrier to contact a back side of a wafer to be transferred, and a pushing mechanism provided on the lateral arm member a distance from the one end corresponding to a center location of a correctly positioned wafer, such that the pushing mechanism pushes the wafer to be transferred in its correct position within the wafer carrier in the event that the wafer to be transferred is misaligned in the carrier with respect to its correct position.

The pushing mechanism is provided on an upper surface of the lateral arm member and the distance from the one end corresponding to the center location of the correctly positioned wafer is approximately equal to the nominal radius of the wafers, and is preferably moveable within a range of 10 mm from this position. One side of the pushing mechanism proximate the wafers in the wafer carrier may be arc-shaped to better capture the wafer. Further, the pushing mechanism may have a thickness less than the width of slots in the wafer carrier holding the wafers.

In another aspect, the present invention provides a transfer apparatus transferring semiconductor wafers to and from a fabrication apparatus, comprising;

a vertically moveable plate, a wafer carrier mounted on the plate and adapted to load, hold, and unload wafers, the wafer carrier having a correct position in which each one of the wafers is loaded, a laterally moveable transfer arm comprising a lateral arm member having one end adapted to horizontally extend into the wafer carrier to contact a back side of a wafer to be transferred, and a first sensor positioned with respect to the plate and wafer carrier, such that it establishes a vertical detection plane proximate an outer edge of the wafers loaded in the wafer carrier. A second horizontal sensor may also be added to the transfer apparatus.

As above, the transfer arm may further comprise a pushing mechanism provided on the lateral arm member a distance from the one end corresponding to a center location of a correctly positioned wafer, such that the pushing mechanism pushes the wafer to be transferred in its correct position within the wafer carrier in the event that the wafer to be transferred is misaligned in the wafer carrier with respect to its correct position.

### BRIEF DESCRIPTION OF THE DRAWINGS

In the accompanying drawings:

FIG. 1 is a schematic representation showing a conventional transfer apparatus for semiconductor wafers;

FIG. 2 is a plan view of the conventional transfer apparatus showing the transportation of wafers;

FIG. 3 is a plan view showing the transportation of the wafers using the conventional transfer arm;

FIG. 4 is a plan view showing the sensing state of the wafers using the conventional sensor of FIG. 1;

FIG. 5 is a schematic representation showing the transfer arm of the transfer apparatus for semiconductor wafers according to one embodiment of the present invention;

FIG. 6 is a plan view of the transfer apparatus showing the sensing state of the wafers using the sensor of FIG. 5; and

FIG. 7 is a schematic representation showing a transfer arm of a transfer apparatus for semiconductor wafers according to another embodiment of the present invention.

### DESCRIPTION OF PREFERRED EMBODIMENTS

The present invention now will be described with reference to the accompanying drawings in which preferred embodiments of the invention are shown.

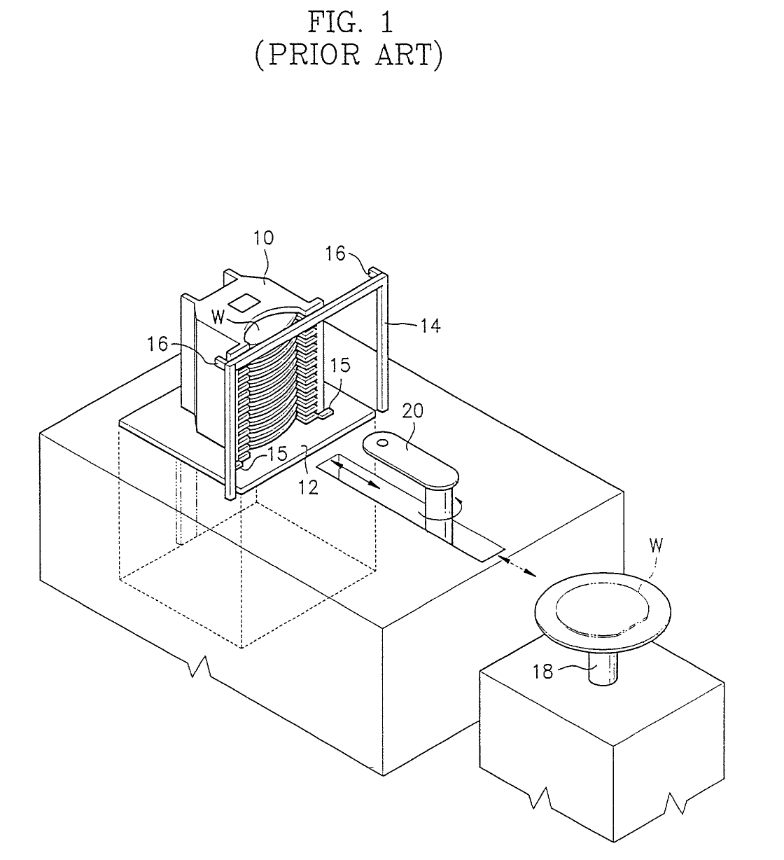

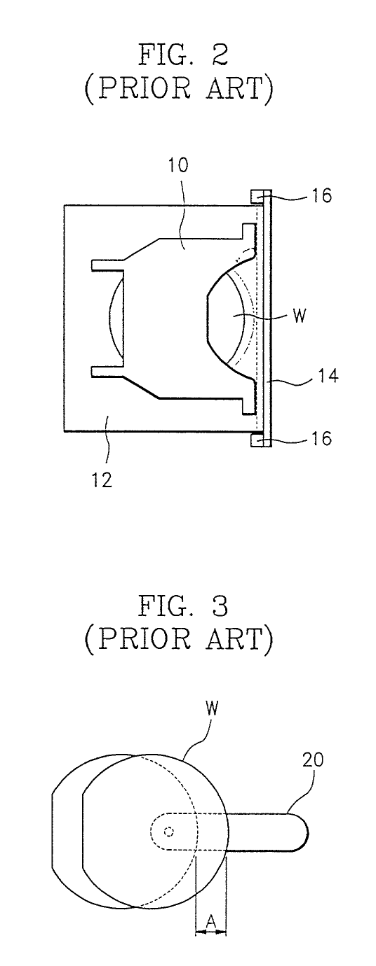

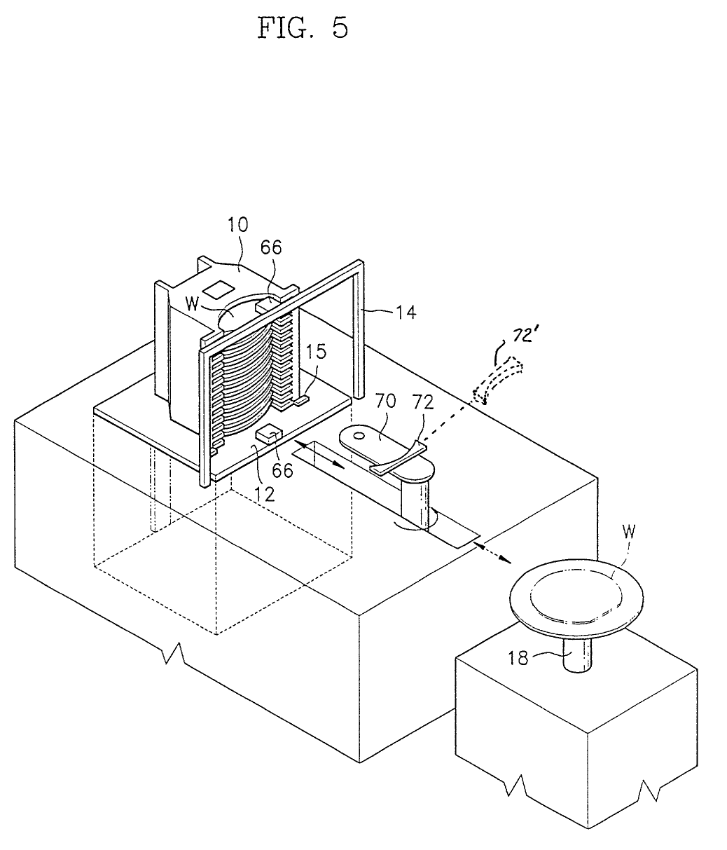

FIG. 5 is a schematic representation showing one embodiment according to the present invention. A description of the structure and operation of the similarly indicated elements with respect to the description given in relation to FIG. 1 is omitted as redundant. Like numbers in the figures refer to like elements throughout.

As shown in FIG. 5, the transfer apparatus for semiconductor wafers comprises a carrier 10 having a plurality of wafers W loaded therein, a plate 12 on which the carrier 10 is mounted, a lateral support 15 stabilizing carrier 10 on plate 12, and a frame 14 mounted on plate 12 for attaching various, supplementary elements. In fact, frame 14 can be variously modified to take many forms, so long as it does not interfere with the movement of carrier 10.

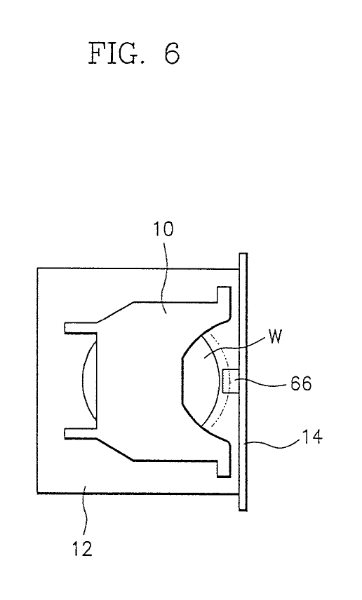

The transfer apparatus according to the present invention also comprises a sensor 66 detecting any misalignment of the wafers from their correct location within carrier 10, and a transfer arm 70 transferring wafers between carrier 10 and fabrication apparatus 18. One side of sensor 66 is provided, and as shown in some additional detail in FIG. 6, on a central portion of frame 14 perpendicular to the wafers in carrier 10. Another side of sensor 66 is provided opposite the one side on plate 12. Sensor 66 is preferably located a predetermined distance apart from the circumferential edge of the wafers as they are correctly loaded within carrier 10.

Both ends of sensor 66 may be active or one may be passive, i.e., reflective. Preferably, sensor 66 comprises a light-emitting diode (LED) on one side, and a light-receiving element on the other side. Sensor 66 may be connected to an alarm mechanism (not shown) indicating misalignment of the wafers within carrier 10. Alternatively, each side of sensor 66 may include a light-emitting element and a light-receiving element integrally installed on frame 14 and plate 12.

In addition, as shown in FIG. 5, transfer arm 70 comprises a lateral arm member having one end adapted to extend into the wafer carrier to contact a wafer. Once in position, transfer arm 70 makes contact with the back (or under) side of the wafer, may fix it to the transfer arm, if desired, and transfers it. Normally, a robot arm, or its equivalent, is used to accomplish the lateral movement. In such cases, the movement of transfer arm 70 is normally calibrated by an operator or by the equipment supplier in advance. A vacuum pad (not shown) may be provided on the one end of transfer arm 70. This element contacts the back side of the wafer during the wafer transfer to fix it by vacuum action.

Transfer arm 70 further includes, as shown in FIG. 5, a pushing mechanism 72 which horizontally pushes a wafer(s) back into its proper place within carrier 10 when it has slipped out, i.e., when it has become misaligned. Pushing mechanism 72 is placed on an upper surface of transfer arm 70 a predetermined distance from the one end corresponding to a center location of a correctly positioned wafer, as the wafer is properly captured by transfer arm 70 prior to transfer. This distance is equal to the nominal radius of the wafer. However, pushing mechanism 72 may move within a range of 10 mm to accommodate variations in a particular wafer. For example, in case of a wafer having a nominal diameter of 150 mm, pushing mechanism 72 is placed on the upper surface of transfer arm 70 and spaced apart by a distance of 75 to 80 mm from the center of the wafer as properly captured by transfer arm 70.

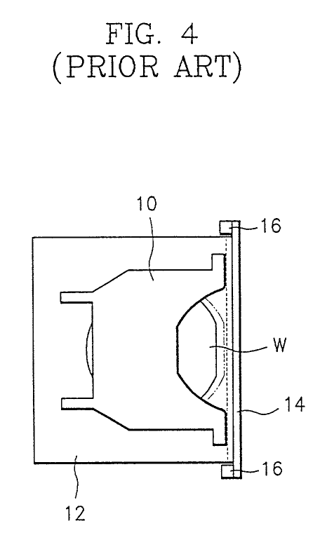

One side of pushing mechanism 72, the side contacting the edge of a captured wafer, may be arc-shaped to increase transfer efficiency. The arcuate shape of the side of the pushing mechanism preferably conforms to the rounded circumferential edge of the wafer that it contacts. However, if the wafers are loaded in the carrier 10 with the flat edge exposed (see, e.g., FIG. 4), the arcuate shaped side of the pushing mechanism may cause misalignment. Accordingly, the pushing mechanism 72 may be made to rotate so that the flat edge of the pushing mechanism 72′ (shown rotated by phantom lines in FIG. 5) contacts the flat edge of the wafer. The thickness of pushing mechanism 72 is preferably less than the width of the slot in carrier 10 holding the wafer. This preference allows pushing mechanism 72 to fit as transfer arm 70 moves to contact the back side of the wafer for transfer.

This transfer arm may be used for the above transfer apparatus, or may be used with a conventional transfer apparatus.

In the exemplary embodiment of the present invention shown in FIG. 6, any wafer, which is deviated from the correct location within carrier 10, can be more precisely sensed by using sensor 66 provided on frame 14 and plate 12. The vertical plane established by sensor 66 does not suffer from the performance limitations of the conventional sensor since it is not obscured by the sides of the carrier 10. In addition, when transfer arm 70 moves forward to capture a wafer(s), pushing mechanism 72 pushes the wafer into a correct location before wafer(s) are transferred. This ability precludes misalignment of the wafers.

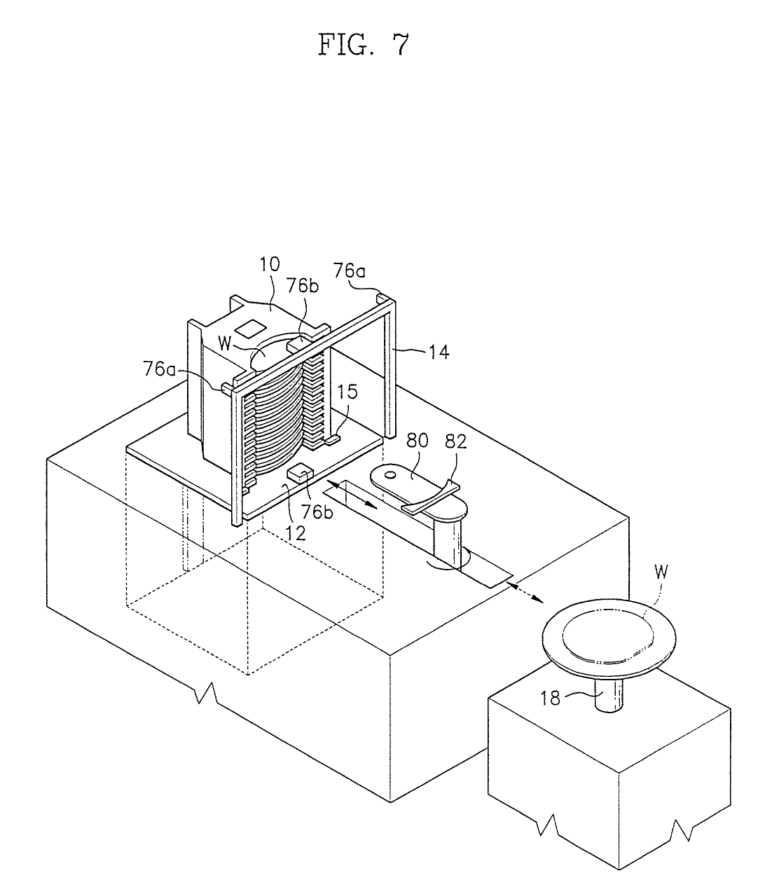

Another embodiment of the present invention is shown in the schematic representation of FIG. 7. In this embodiment, a first sensor 76a is provided to detect wafer misalignment in the horizontal direction. That is, opposite sides of sensor 76a are placed on frame 14 to establish a horizontal sensing plane. There is also provided a second sensor 76b. Second sensor 76b has one side on plate 12 and another side opposite the first on frame 14 to detect wafer misalignments in the vertical direction. For either sensor 76a and/or 76b, the sensor may comprise a light-emitting element and a light-receiving or reflecting element as discussed above. Transfer arm 80 and pushing mechanism 82 may also be provided in the same manner as transfer arm 70 and pushing mechanism 72 discussed above. Accordingly, wafers are sensed in the horizontal direction and in the vertical direction, and by using transfer arm 80 and pushing mechanism 82 any misalignment of the wafers is corrected in real time. Such assurance of proper alignment provides maximum production efficiency.

The operation of the above embodiments of the present invention will now be described.

To begin, the structure of carrier 10 and plate 12 are studied in view of the present invention. Further, the proper position of the wafers within carrier 10, as well as the range of possible misalignment of the wafers is studied. With an understanding of these relationships, the position of sensor 66 (or the position of sensors 76a and 76b) is (are) determined. Further, these relationships taken with the desired position of transfer arm 70 (transfer arm 80) when capturing the wafer(s), defines the location of pushing mechanism 72 on transfer arm 70.

Thus, alignment of the wafers within carrier 10 is assured and any misalignment may be corrected by pushing mechanism 72 and action of the transfer arm 70 before the wafer is transferred to fabrication apparatus 18. Accordingly, only correctly loaded wafers within carrier 10 can be transferred to fabrication apparatus 18 for a subsequent processing. Ensuring correct placement of a wafer into fabrication apparatus 18 facilitates efficient subsequent processing without the risk of wafer transfer induced process failures. For example, in a case where fabrication apparatus 18 is an exposure apparatus or a development apparatus performing a photoetching process, process failures due to misalignment of the wafer can be minimized.

The advantages of the present invention arise not so much from complex computer control, but from careful structural and spatial relationships created to overcome problems associated with the prior art and to maximize handling accuracy and transfer efficiency of the wafers. Installation of additional sensors or realignment of the existing sensors is certainly possible. Sensor number and location may vary with the structure of the carrier, plate and wafers, as well as the movement and location of the transfer arm. In fact, one of ordinary skill in the art will recognize many changes, substitutions, and alterations to the embodiments above. Such are given as examples, not as limitations to the present invention which is defined by the following claims.

What is claimed is:

1. A transfer arm transferring semiconductor wafers from a wafer carrier to a fabrication apparatus, the wafer carrier having a correct position in which each one of the wafers is placed, the transfer arm comprising:
a lateral arm member having one end adapted to extend into the wafer carrier to contact a back side of a wafer to be transferred; and
a pushing mechanism provided on the lateral arm member a distance from the one end corresponding to a center location of a correctly positioned wafer, such that the pushing mechanism pushes the wafer to be transferred in its correct position within the wafer carrier in the event that the wafer to be transferred is misaligned in the wafer carrier with respect to its correct position.

2. The transfer arm of claim 1, wherein the pushing mechanism is provided On an upper surface of the lateral arm member and the distance from the one end corresponding to the center location of the correctly positioned wafer is approximately equal to the nominal radius of the wafers.

3. The transfer arm of claim 2, wherein the pushing mechanism is moveable within a range of 10 mm from a position defined by the nominal radius of the wafers.

4. The transfer arm of claim 2, wherein the pushing mechanism is provided at a distance from the one end corresponding to the center location of the correctly positioned wafer in a range of from 75 mm to 80 mm.

5. The transfer arm of claim 1, wherein a side wall of the pushing mechanism, proximate a rounded circumferential edge of the wafer in the wafer carrier, is arcuate shaped.

6. The transfer arm of claim 1, wherein a side wall of the pushing mechanism, proximate a flat circumferential edge of the wafer in the wafer carrier, is linearly shaped.

7. The transfer arm of claim 1, wherein the wafer carrier comprises a plurality of horizontal slots, each horizontal slot formed with a width adapted to receive and hold a wafer, and wherein the pushing mechanism has a thickness less than the width of each horizontal slot in the wafer carrier.

8. The transfer arm of claim 1, wherein the one end comprises a vacuum pad adapted to adhere to the back side of the wafer to be transferred.

9. A transfer apparatus transferring semiconductor wafers to and from a fabrication apparatus, comprising:
a vertically moveable plate;
a wafer carrier mounted on the plate and adapted to load, hold, and unload wafers, the wafer carrier having a correct position in which each one of the wafers is loaded;
a laterally moveable transfer arm comprising a lateral arm member having one end adapted to horizontally extend into the wafer carrier to contact a back side of a wafer to be transferred; and
a first sensor positioned with respect to the plate and wafer carrier, such that it establishes a vertical detection plane proximate an outer edge of the wafers loaded in the wafer carrier.

10. The transfer apparatus of claim 9, wherein the transfer arm further comprises a pushing mechanism provided on the lateral arm member a distance from the one end corresponding to a center location of a correctly positioned wafer, such that the pushing mechanism pushes the wafer to be transferred in its correct position within the wafer carrier in the event that the wafer to be transferred is misaligned in the wafer carrier with respect to its correct position.

11. The transfer apparatus of claim 10, wherein the vertical detection plane is established a distance apart from the circumferential edge of the wafers when the wafers are loaded into their correct position.

12. The transfer apparatus of claim 10, further comprising a frame mounted on the plate between the wafer carrier and the transfer arm for attaching various supplementary parts.

13. The transfer apparatus of claim 12, wherein the first sensor comprises first element mounted on a center portion of the frame and a second element mounted on the plate opposite the first element, the first and second elements establishing the vertical detection plane.

14. The transfer apparatus of claim 13, wherein the first element is a light-emitting device, and the second element is a light-receiving device.

15. The transfer apparatus of claim 13, wherein one of the first or second elements comprises a combination of a light-emitting device and a light-receiving device integrally provided on one of the frame and plate.

16. The transfer apparatus of claim 9, further comprising a second sensor positioned with respect to the wafer carrier so as to define a horizontal detection plane.

17. The transfer apparatus of claim 9, wherein the first and second sensors cooperate to detect a misalignment of any wafer in the wafer carrier.
